(19) United States
(12) Patent Application Publication
(10) Pub. No.: US 2026/0208462 A1
(43) Pub. Date: Jul. 23, 2026

(54) FLAP-CUTTING DEVICE FOR A CONVERTING MACHINE

(71) Applicant: BOBST LYON, Bron Cedex (FR)

(72) Inventors: Eric VERNAY, Orliénas (FR); Michel MOUCHON, Mions (FR); Franck RILAT, La Terrasse sur Dorlay (FR)

(73) Assignee: BOBST LYON, Bron Cedex (FR)

(21) Appl. No.: 19/140,881

(22) PCT Filed: Dec. 14, 2023
(86) PCT No.: PCT/EP2023/085849

§ 371 Date: Jun. 18, 2025

(30) Foreign Application Priority Data
Dec. 28, 2022 (EP) 22315358.6

(51) Int. Cl. B31B 50/22; B31B 50/14; B31B 100/00; B31B 110/35

(52) U.S. Cl. CPC B31B 50/22; B31B 50/146; B31B 2100/0022; B31B 2110/35

(57) ABSTRACT

The present invention relates to a flap-cutting device (28) for cutting out a flap in a blank (2) transported in a direction of transportation (T) through a converting machine 1. The flap-cutting device comprises a center rotational axis (32) arranged in the gravitational center of the flap-cutting device. Only three extensions in the form of a first tool carrying extension (34a), a second tool carrying extension (34b), and a third extension (36) provided with a counterweight (37) extend from the center pivot point. The first and second tool carrying extensions are each connectable to a first and a second cutting tools (38a, 38b).

### FIELD OF THE INVENTION

The present invention relates to a flap-cutting device for a converting machine. The converting machine is configured to produce packaging elements such as folding boxes from paper and cardboard.

### BACKGROUND

Converting machines such as flexo folder gluers produce folding boxes and other similar folded packaging elements. These converting machines comprise a plurality of workstations which print and process a sheet substrate to transform it into a printed cut-to shaped blank and then into packaging elements such as folding boxes. A flexo-folder gluer comprises a slotter module having disc-shaped cutting and creasing tools which cut and crease the sheet substrate.

There are several types of folding boxes, and many of them require a blank with a glue flap. An example of such a box is an American-style box. The glue flap is cut out by a side-mounted flap-cutting device provided with two cutting blades.

An example of a side-mounted flap-cutting device with four legs is disclosed in document EP2750874. A first and second blades are mounted to two of the respective legs, while the remaining two legs serve as counterweights.

Depending on the desired length of the glue flap, the flap-cutting device can be configured to rotate at different speeds during one revolution. The different speeds are achieved by momentary accelerations and decelerations. However, the accelerations and decelerations are limited by the size of the flap-cutting tool.

### SUMMARY

In view of the prior art, it is an object of the present invention to provide a flap-cutting device which allows a wide range of flap sizes to be cut, while ensuring a high production speed through the converting machine.

This object is solved by a flap-cutting device according to claim 1.

According to a first aspect of the present invention, there is provided a flap-cutting device for cutting out a flap in a blank transported in a direction of transportation through a converting machine. The flap-cutting device comprises a center rotational axis arranged in the gravitational center of the flap-cutting device. The flap-cutting device comprises only three extensions in the form of a first tool carrying extension, a second tool carrying extension, and a third extension provided with a counterweigh. The first and second tool carrying extensions are each respectively connectable to a first and a second cutting tools.

The three extensions extend from the center rotational axis.

Preferably, a radial length of the first and second tool carrying extensions are equal, and the third extension is shorter than the first and second tool carrying extensions.

In an embodiment, the angle between the first tool carrying extension and the second tool carrying extension can be between 80° to 90°, preferably about 87°.

The first and second cutting tools preferably comprise a first and a second elongated cutting edges, respectively. The cutting edges are extending in a traverse direction in relation to the direction of transportation.

In an embodiment, the first cutting edge is positioned in a first direction and the second cutting edge is positioned in a second direction, and the first and second directions are extending at opposite angles in relation to the direction of transportation.

In an embodiment, the first and second cutting edges are positioned in the same direction in relation to the direction of transportation.

In an embodiment, the cutting edges extend in a perpendicular direction in relation to the direction of transportation

In an embodiment, the flap-cutting device is made from aluminum or titanium. The counterweight may be casted in one piece together with the third extension and the first and second tool carrying extensions.

According to a second aspect of the present invention, there is provided a double slotter module, such as using flap-cutting devices as described, comprising a first slotter assembly and a second slotter assembly, wherein the first slotter assembly comprises a first flap-cutting device and the second slotter assembly comprises a second flap-cutting device. The first and second flap-cutting devices having only three extensions in the form of a first tool carrying extension, a second tool carrying extension, and a third extension provided with a counterweight. The first and second tool carrying extensions are respectively connectable to a first and a second cutting tools.

In an embodiment, the first tool carrying extension and the second tool carrying extension of the first flap-cutting device comprises cutting tools having cutting edges positioned in a first direction in relation to the direction of transportation, and the first and second tool carrying extensions of the second flap-cutting device comprises cutting tools having cutting edges positioned in a second direction in relation to the direction of transportation. The first direction and second directions are opposite in relation to the direction of transportation of a blank.

The cutting edges may be arranged obliquely in relation to the direction of transportation.

### BRIEF DESCRIPTION OF THE DRAWINGS

The invention will now be described with reference to the appended drawings, in which like features are denoted with the same reference numbers and in which:

FIG. 1 is a schematic view of a converting machine in the configuration of a flexo-folder gluer;

FIG. 2a is a schematic top view of a blank produced in the converting machine of FIG. 1;

FIG. 2b is a schematic top view of another type of blank produced in the converting machine of FIG. 1;

FIGS. 3a and 3b are schematic perspective views of a folding box and an assembled folding box;

FIG. 4 is a schematic side view of a slotter assembly according to the prior art;

FIG. 5 is a schematic side view of a double slotter assembly according to the prior art;

FIG. 6 is a schematic cross-sectional view of a flap-cutting assembly according to an embodiment of the present invention;

FIG. 7 is a schematic cross-sectional view of a flap-cutting device according to an embodiment of the present invention;

FIG. 8 is a schematic diagram of an exemplary double slotter configuration for producing juxtaposed blanks; and

FIG. 9 is a schematic diagram of an exemplary double slotter configuration for producing single blanks.

### DETAILED DESCRIPTION

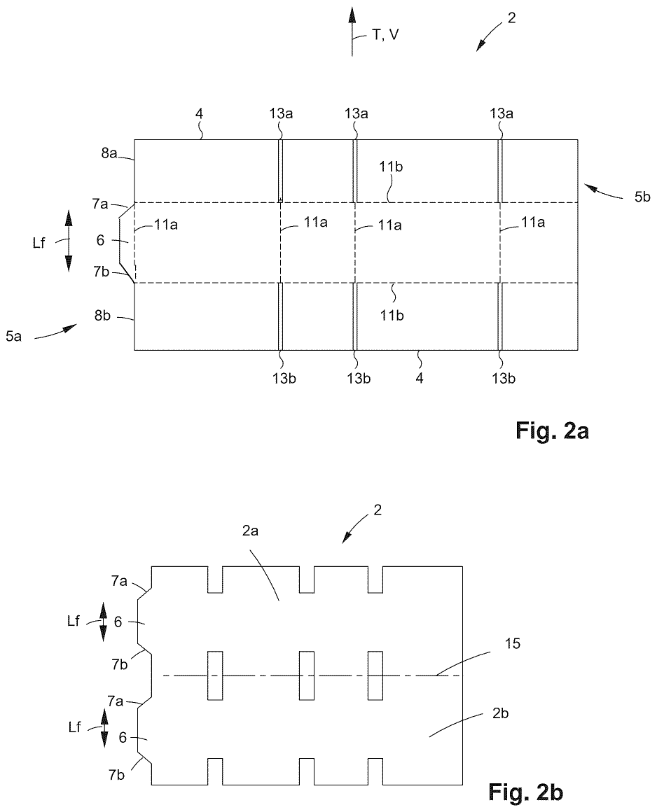

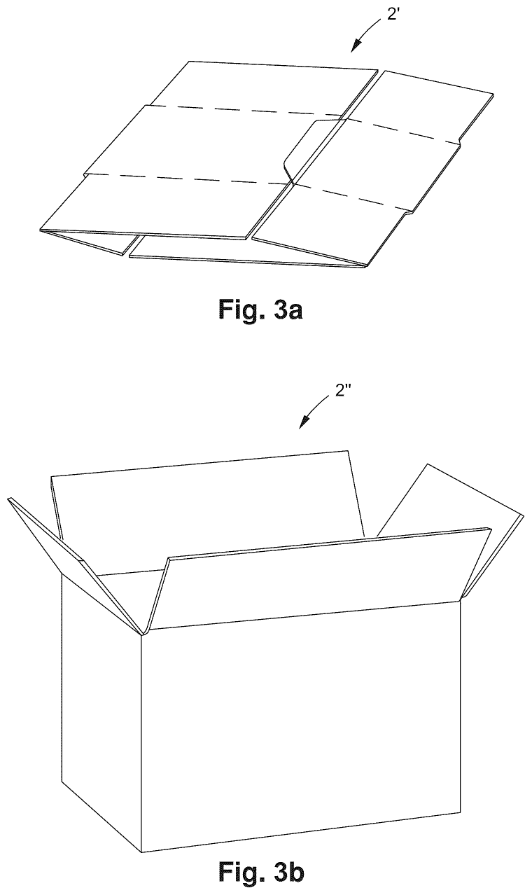

Referring to the figures, and in particular FIGS. 2a and 2b which show examples of a blank 2 made from cardboard and which is used for manufacturing a folding box 2′, such as the one shown in FIG. 3a.

When a folding box 2′ is manufactured, a sheet substrate goes through a plurality of workstations in a converting machine 1 which may transform the sheet substrate into a blank 2 by printing, cutting, gluing and folding the sheet substrate.

The blank 2, before gluing and folding, may generally present a rectangular flat shape with two parallel edges 4 of larger length. The folding box 2′ can in a final step be assembled to form a three-dimensional box 2″ as the one illustrated in FIG. 3b. To enable folding of the blank 2 into a three-dimensional box 2″, a plurality of crease lines 11a, 11b is needed.

In relation to a direction of transportation T, the blank 2 is provided with two lateral edges 5 in the form of a left edge 5a and a right edge 5b. In the illustrated example, the left edge 5a presents cutouts 7a, 7b so as to define a flap 6 in the middle of the left edge 5a.

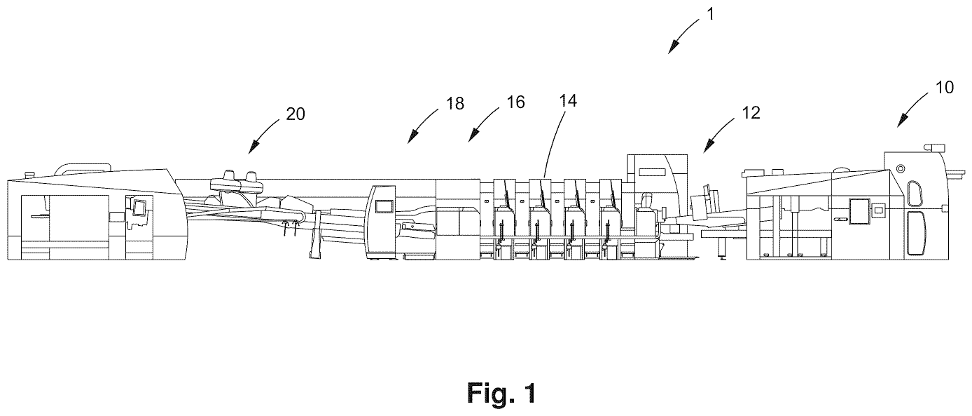

A converting machine 1 in the form of a flexo-folder gluer is schematically illustrated in FIG. 1. The converting machine 1 may comprise successively in a direction of transportation T: a loader 10 for automatically loading the sheet substrates, a feeder 12, optionally a plurality of flexography printing units 14, a converting unit 16 comprising a slotter module with at least one slotter assembly 17, at least one cutting unit 18, and a folding-gluing unit 20. The converting machine 1 may also further comprise optional modules such as a counting-ejecting unit, a bundler and a palletizer (not illustrated).

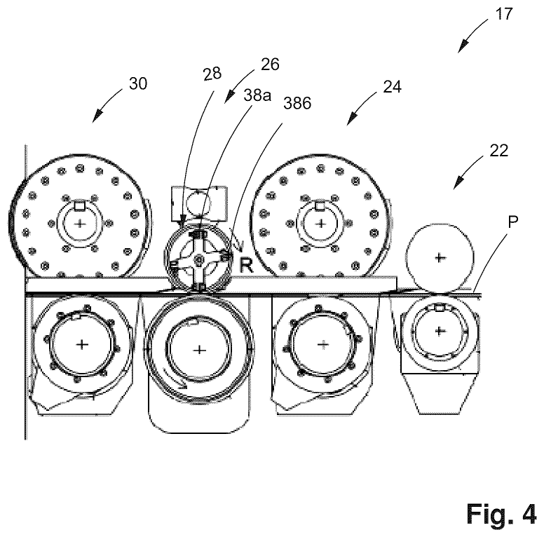

As illustrated in FIG. 4, the slotter assembly 17 comprises a precreasing section 22, a first slotting section 24, a creasing section 26, a flap-cutting device 28 and a second slotting section 30. The slotter assembly 17 is equipped with rotary tools including creasing tools configured to perform crease lines and cutting tools configured to cut through the blank 2. The cutting and creasing tools are mounted on transverse shafts which are driven in rotation by shaft motors. The tangential speed of rotation of the tools preferably corresponds to the transportation speed V of the blank 2.

The precreasing section 22 comprises a first pair of shafts positioned one above the other. The precreasing section 22 precreases and prepares the blank 2 for the subsequent creasing of a priority folding line.

The first slotting section 24 is arranged downstream of the precreasing section 22 and is configured to perform a first and second edge cuts 8a, 8b (see FIG. 2a) and to cut the slits 13b placed at the rear of the blank 2. The first slotting section 24 comprises a second pair of shafts positioned one above the other. The upper shaft of the first slotting section 24 is provided with a disc equipped with cutting blades and the lower shaft is provided with a lower counter blade.

The creasing section 26 is arranged downstream of the first slotting section 24. The creasing section 26 comprises a third pair of shafts positioned one above the other. The lower shaft of the creasing section may be provided with a lower creaser and the upper shaft may be provided with an upper creaser, which is the counterpart of the lower creaser. However, it is also possible to arrange the tools the other way around. The creasing tools in the slotter assembly 17 perform the longitudinal crease lines 11a. It will be noted that the transverse crease lines 11b may be performed upstream or downstream of the slotter assembly 17, or are initially provided in the sheet substrate.

The creasing section 26 thus carries out the second and final creasing operation, including the formation of the priority crease line and ensures the permanent and precise marking of the longitudinal crease lines 11a.

The second slotting section 30, with a fourth pair of shafts positioned one above the other, is mounted downstream of the creasing section 26. The upper shaft of the second slotting section is provided with a disc equipped with cutting blades and the lower shaft is provided with a lower counter blade. The second slotting section cuts the slits 13a positioned at the front of the blank 2.

The slotter assembly further comprises a flap-cutting device 28. The flap-cutting device 28 may be positioned in the creasing section 26. The flap-cutting device 28 is positioned in a lateral position of the converting machine 1, at the edge of the transportation path P of the blank in the converting machine 1.

The flap-cutting device 28 comprises a first cutting tool 38a and a second cutting tool 38b configured to perform the front and rear cuts 7a, 7b in a perpendicular or oblique direction in relation to the lateral edge 5a of the blank 2. The first and second cutting tools 38a, 38b are cutting blades provided with an elongated cutting edge 39a, 39b. Hence, the front and rear cuts 7a, 7b are performed in a direction which is perpendicular or transverse to the direction of transportation T.

The flap 6 is cut out from the rest of the lateral edge 5a of the blank 2 by performing a first longitudinal cut 8a and a second longitudinal cut 8b with a first and second peripherally mounted slotter discs in the first slotting section 17. The first and second longitudinal cuts 8a, 8b define the length Lf of the flap 6 in the direction of transportation T. Hence, the longer the first and second longitudinal cuts 8a, 8b are, the shorter “uncut length” is left for the flap 6.

As illustrated in FIG. 2b, some types of blanks 2 contain a plurality of juxtaposed blanks 2a, 2b joined together by frangible lines 15. The frangible line 15 may be subsequently ruptured in a breaker device in the converting machine 1, such as the one described in EP3445549. The juxtaposed blanks 2a, 2b each comprise similar transverse and longitudinal crease-lines 11a, 11b as the blank 2 illustrated in FIG. 2a.

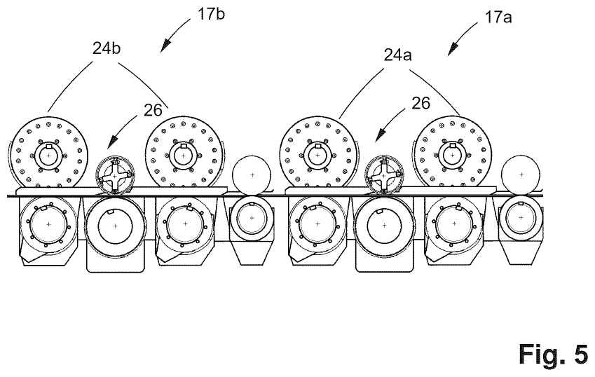

For these types of juxtaposed blanks 2, and as illustrated in FIG. 5, the cutting and scoring operations can be shared between a first slotter assembly 17a and a second slotter assembly 17b. Such a slotter module can be referred to as a “double slotter”. A double slotter module is capable of ensuring a high production speed because the cutting operations are partially shared between collaborating cutting tools.

Each slotter assembly 17a, 17b may comprise a separate creasing unit 26 with a flap-cutting device 28. The double slotter thus allows the cutout of a plurality of juxtaposed blanks 2a, 2b from the same sheet substrate. Such a double slotter arrangement is further described in document EP3934903.

The length Lf of the flap 6 in the direction of transportation T can be modified by momentarily changing the rotation speed of the flap-cutting device 28 when the cutting tools 38a, 38b of the flap-cutting device 28 are not in contact with the blank 2. Additionally, the angular position of the cutting blades on the first and second slotting sections 24a, 24b are adjusted in order to provide a different length of the cuts 8a, 8b.

The front and rear cuts of the flap 7a, 7b are performed with the flap-cutting device 28 having a tangential speed corresponding to the transportation speed V of the blank 2. Hence, at the time of the front and rear cuts 7a, 7b of the flap 6, when the cutting tools 38a, 38b cut into the blank 2, the tangential speed of the flap-cutting device 28 is equal to the transportation speed V of the blank 2.

The front cut 7a may be performed first, and then the rear cut 7b is performed. The rotational speed of the flap-cutting device 28 can be different from the transportation speed V between the front cut 7a and the rear cut 7b. The rotational speed of the flap-cutting device 28 can be momentarily increased between the front cut 7a and the rear cut 7b to make a shorter flap 6. Conversely, if the rotational speed is momentarily decreased between the front cut 7a and the rear cut 7b, the flap 6 will be longer. Consequently, a momentary deceleration of the flap-cutting device 28 thus results in a longer flap 6, while a momentary acceleration results in a shorter flap 6.

The diameter of the flap-cutting device 28 sometimes needs to be adapted to the diameters of the other rotary processing tools in the converting machine 1. Typically, a larger flap-cutting device 28 is required when the diameters of the printing cylinders change.

A larger flap-cutting device 28 has an increased diameter and a larger distance between the cutting tools 38a, 38b. The weight and inertia of large flap-cutting device 28 have a restrictive effect on the possible achievable accelerations and decelerations. It can therefore be difficult to obtain some flap lengths Lf at high transportation speeds.

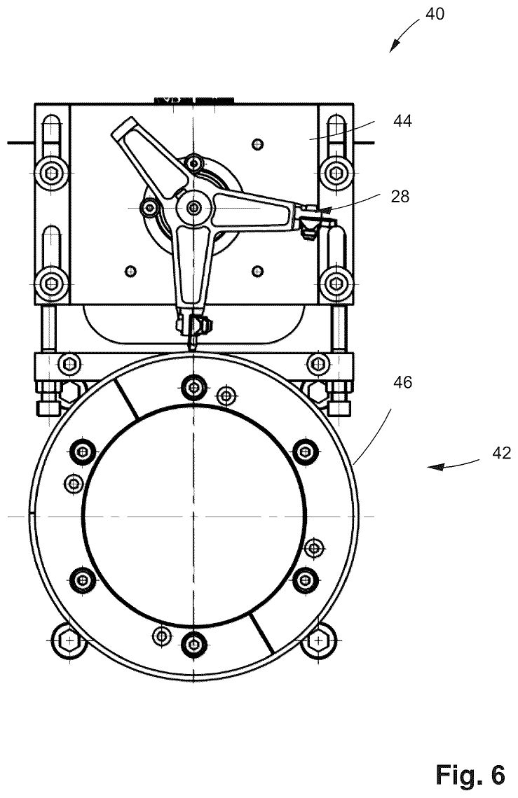

As illustrated in FIG. 6, a flap-cutting assembly 40 of the present invention comprises a flap-cutting device 28, a counter-cylinder and 42 chassis 44. The flap-cutting device 28 and the counter-cylinder 42 are rotationally mounted to the chassis 44. The counter-cylinder 42 may be provided with a resilient layer 46 that contacts the cutting edges 39a, 39b of the first and second cutting tools 38a, 38b.

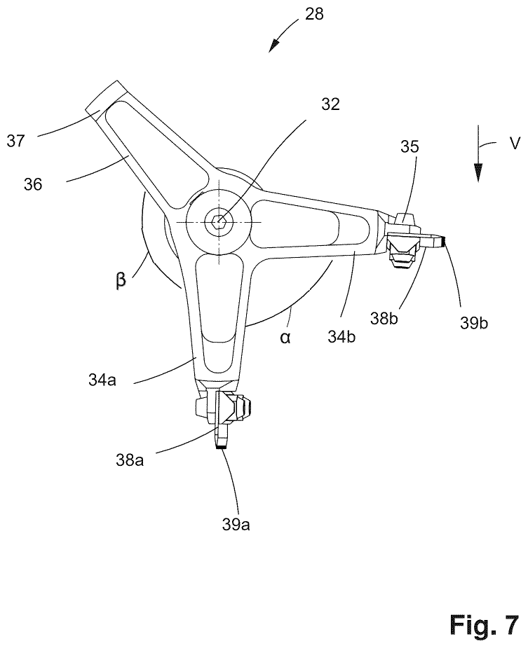

As best seen in FIG. 7, the flap-cutting device 28 according to an embodiment of the present invention comprises a center rotational axis 32 arranged in the gravitational center of the flap-cutting device 28. A first tool carrying extension 34a and a second tool carrying extension 34b extend radially from the center rotational axis 32.

A first cutting tool 38a and a second cutting tool 38b are connected to the respective distal ends of the first tool carrying extension 34a and the second tool carrying extension 34b. A third extension 36 extending from the center rotational axis 32 is provided with a counterweight 37. The flap-cutting device 28 thus only comprises three extensions 34a, 34b, 36. The radial length of the first tool carrying extension 34a and the second tool carrying extension 34b are equal.

The third extension 36 can also be referred to as a “counterweight extension” 36. The counterweight 37 can be fixedly mounted, in one piece with the flap-cutting device 28. For instance, the counterweight 37 can be casted in one piece together with the first, second and third extensions 34a, 34b, 36. Alternatively, the counterweight 37 is removably mounted to the third extension 36. In such a way, the weight of the counterweight 37 can be adapted to the weight of the first and second cutting blades 38a, 38b.

The radial length of the counterweight extension 36 may be shorter than the radial length of the first and second tool carrying extensions 34a, 34b. This allows the counterweight 37 to rotate without touching the blank 2.

The first tool carrying extension 34a and the second tool carrying extension 34b are positioned with an angle α in-between them. The angle α between the central axis of first tool carrying extension 34a and the central axis of the second tool carrying extension 34b may be between 80° and 90°, preferably 87°. The counterweight extension 36 is positioned at an angle β from the first tool carrying extension 34a. As the flap-cutting device 28 is symmetrical, the counterweight extension 36 is positioned at an angle β from either the central axis of the first tool carrying extension 34a or the central axis of the second tool carrying extension 34b. The angle β is between 140° and 135°, preferably 136.5°.

Hence, the angle β=(360°−α)/2

The weight of the counterweight 37 is selected such that the flap-cutting device 28 is balanced and in equilibrium through a 360° rotation of the flap-cutting device 28.

The first and second tool carrying extensions 34a, 34b may be each be provided with a fastener 35, allowing the first and second cutting tools 38a, 38b to be replaced.

The cutting tools 38a, 38b may be positioned with the cutting edges 39a, 39b extending in two opposite oblique directions D1, D2 in relation to the direction of transportation T. This configuration is advantageous for a slotter module comprising only one slotter assembly 17. This allows the flap-cutting device 28 to provide two oblique cuts 7a, 7b in opposite directions and provide a symmetrical flap 6.

Alternatively, for flaps 6 with a rectangular flap 6, the cutting tools 38a, 38b extend in a direction perpendicular to the direction of transportation T. These two configurations allow one single flap-cutting device 28 to cut out a flap 6.

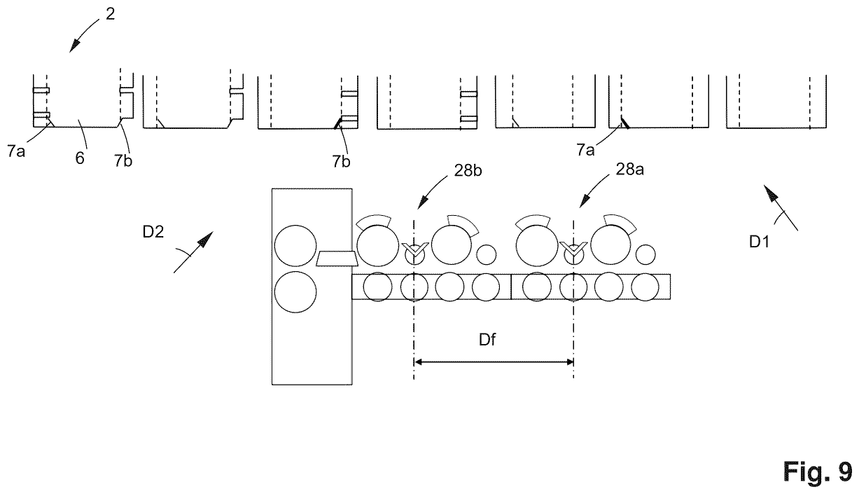

However, for a double-slotter module as the one illustrated in FIG. 5, the double slotter module can also be configured for processing a single blank 2 with a cooperating first flap-cutting device 28a and a second flap-cutting device 28b. As best seen in FIG. 9, the first flap-cutting device 28a may be positioned at a distance Df upstream of the second flap-cutting device 28b in the direction of transportation T. In this embodiment, it is advantageous to provide the first flap-cutting device 28a with a cutting edge 39a extending obliquely in the first direction D1. The second flap-cutting device 28b is configured identically to the first flap-cutting device 28a, but with a cutting edge 39a extending in a second direction D2, opposite to the first direction.

This is further illustrated in FIG. 9, where the first flap-cutting device 28a perform a front cut 7a and the second flap-cutting device 28b perform a rear cut 7b of the flap 6. The first and second cuts 7a, 7b are in an opposite direction D1, D2 in relation to each other.

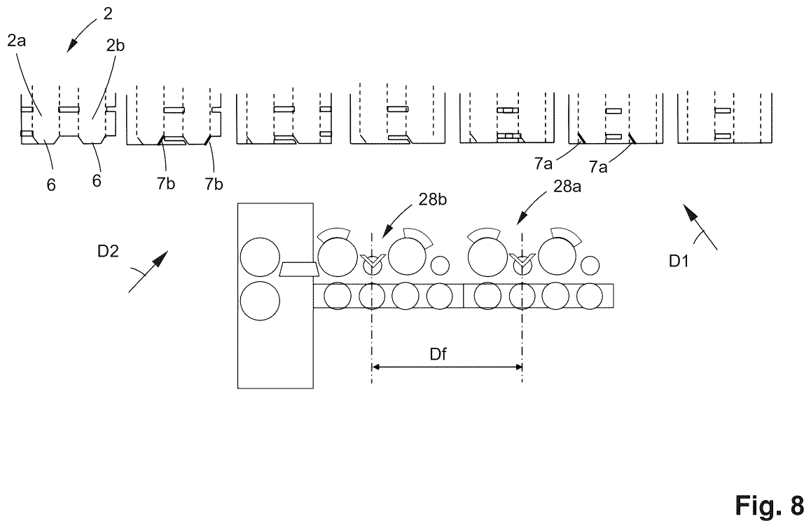

When processing composed blanks 2 with at least two juxtaposed blanks 2a, 2b, and as illustrated in FIG. 8, the first flap-cutting device 28a may comprise tool fasteners 35 configured to position both the first cutting edge 39a and the second cutting edge 39b in a first direction D1. Similarly, the second flap-cutting device 28b may comprise tool fasteners 35 configured to position both the first cutting edge 39a and the second cutting edge 39b in a second direction D2. The first direction D1 and the second direction D2 are opposite to each other.

The first flap-cutting device 28a perform a front cut 7a on each of a first and a second juxtaposed blanks 2a, 2b, while the second flap-cutting device 28b performs a rear cut 7b on each of the first and a second juxtaposed blanks 2a, 2b. In other words, each individual flap 6 is cut out from the two flap-cutting devices 28a, 28b working together. The advantages of using a first and a second flap-cutting devices 28a, 28b is that there is no limit for the sheet thickness and it also allows waste to be cut off. For a single blank 2, there is no limit in the length of the flap 6.

In the embodiments illustrated in FIGS. 8 and 9, the first and second flap cutting devices 28a, 28b may have a first and a second tool extensions and a first and second counterweight extensions (as illustrated in FIG. 4). However, the cutting blades of the first flap-cutting device 28a and the cutting blades of the second flap-cutting device 28b are arranged in opposite directions D1, D2.

However, it is advantageous in the configurations of FIGS. 8 and 9 to use a first and a second flap-cutting tools 28a, 28b as illustrated in FIG. 7, where the first flap-cutting device 28a has a first and a second cutting edges 39a, 39b extending in a first direction D1 and the second flap-cutting device 28b has a first and a second cutting edges 39a, 39b extending in a second direction D2.

1. A flap-cutting device for cutting out a flap in a blank transported in a direction of transportation through a converting machine, the flap-cutting device comprising a center rotational axis arranged in the gravitational center of the flap-cutting device, the flap-cutting device comprising only three extensions in the form of a first tool carrying extension, a second tool carrying extension, and a third extension provided with a counterweight, and wherein the first and second tool carrying extensions are each respectively connectable to a first and a second cutting tools.

2. The flap-cutting device according to claim 1, wherein a radial length of the first tool carrying extension and the second tool carrying extension are equal, and wherein the third extension is shorter than the first and second tool carrying extensions.

3. The flap-cutting device according to claim 1, wherein an angle between the first tool carrying extension and the second tool carrying extension is between 80° to 90°, preferably about 87°.

4. The flap-cutting device according to claim 1, wherein the first and second cutting tools respectively comprise a first and a second elongated cutting edges, extending in a traverse direction in relation to the direction of transportation.

5. The flap-cutting device according to claim 4, wherein the first cutting edge is positioned in a first direction and the second cutting edge is positioned in a second direction, and wherein the first and second directions are extending at opposite angles in relation to the direction of transportation.

6. The flap-cutting device according to claim 4, wherein the first and second cutting edges are positioned in the same direction in relation to the direction of transportation.

7. The flap-cutting device according to claim 4, wherein the cutting edges extend in a perpendicular direction in relation to the direction of transportation.

8. The flap-cutting device according to claim 1, wherein the flap-cutting device is made from aluminum or titanium.

9. The flap-cutting device according to claim 1, wherein the counterweight is casted in one piece together with the third extension and the first and second tool carrying extensions.

10. A double slotter module using the flap-cutting device according to claim 1, comprising a first slotter assembly and a second slotter assembly, wherein the first slotter assembly comprises a first flap-cutting device and the second slotter assembly comprises a second flap-cutting device, the first and second flap-cutting devices having only the three extensions in the form of the first tool carrying extension, the second tool carrying extension, and the third extension provided with the counterweight, and wherein the first and second tool carrying extensions are respectively connectable to the first and the second cutting tools.

11. The double slotter module according to claim 10, wherein the first tool carrying extension and the second tool carrying extension of the first flap-cutting device comprises cutting tools having cutting edges positioned in a first direction in relation to the direction of transportation, and wherein the first and second tool carrying extensions of the second flap-cutting device comprises cutting tools having cutting edges positioned in a second direction in relation to the direction of transportation, and wherein the first direction and second directions are opposite in relation to the direction of transportation of a blank.

12. The double slotter module according to claim 11, wherein the cutting edges are arranged obliquely in relation to the direction of transportation.
